(19) United States
(12) Patent Application Publication
(10) Pub. No.: US 2006/0269220 A1
(43) Pub. Date: Nov. 30, 2006

(54) Reproducing system, reproducing apparatus, receiving and reproducing apparatus, and reproducing method

(75) Inventor: Daisuke Ishido, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/438,322

(22) Filed: May 23, 2006

(30) Foreign Application Priority Data
May 31, 2005 (JP) 2005-159595

(51) Int. Cl. H04N 5/93

(52) U.S. Cl. 386/52

(57) ABSTRACT

A reproducing system includes a master apparatus, at least one slave apparatus, and a communication unit for performing communications via a predetermined communication network between the master apparatus and the slave apparatus. The master apparatus includes a first storage unit for storing data, an edit-control information transmission control unit for transmitting edit-control information to the slave apparatus via the communication unit and a synchronization unit for synchronizing a reproduction output of the master apparatus with a reproduction output of the slave apparatus in reproduction sequence. The slave apparatus includes a second storage unit.

### CROSS REFERENCES TO RELATED APPLICATIONS

The present invention contains subject matter related to Japanese Patent Application JP 2005-159595 filed in the Japanese Patent Office on May 31, 2005, the entire contents of which are incorporated herein by reference.

### BACKGROUND OF THE INVENTION

1. Field of the Invention

The present invention relates to a reproducing system including a reproducing apparatus providing a reproduction output by editing data, and a reproducing method of the system. The present invention also relates to a reproducing apparatus and a receiving and reproducing apparatus forming the reproducing system.

2. Description of the Related Art

Along with widespread use of networks such as the Internet and local area networks (LANs), a variety of audios and videos are enjoyed in a variety of ways on recording and reproducing apparatuses connected to the network.

Japanese Unexamined Patent Application Publication No. 2004-364186 discloses a system including a recording and reproducing apparatus connected to such a network.

In the disclosed technique, two television program recording apparatuses designed to record television programs are connected to a network. Preprogrammed recording information set in one of the television program recording apparatus is transmitted to the other television program recording apparatus so that the same television program can be recorded on the two apparatuses.

When the recording of the same television program on the two television program recording apparatuses has been completed, operation information relating to the reproduction of the recorded program performed on at least one television program recording apparatus is transmitted to the other television program recording apparatus via the network. The same recorded program is reproduced on the two television program recording apparatuses in a generally synchronized reproduction state.

In such an arrangement, a program to be preprogrammed recorded on one television program recording apparatus is also preprogrammed recorded on the other television program recording apparatus. As a result, users of a plurality of television program recording apparatuses can share the same broadcast program content. Since the shared recorded program can be reproduced at almost the same time on the two television program recording apparatuses, time of program viewing is also shared. In accordance with the technique disclosed in Japanese Unexamined Patent Application Publication No. 2004-364186, network connection of the recording and reproducing apparatuses provides entertainment that has never been enjoyed before.

### SUMMARY OF THE INVENTION

It is desirable to enhance the above-described known technique and even higher quality of amusement and functionality. In accordance with the above-described known technique, a content of a preprogrammed recorded program is simply reproduced in synchronization with the original form thereof maintained.

In one embodiment of the present invention, a reproducing system includes a master apparatus, at least one slave apparatus, and a communication unit for performing communications via a predetermined communication network between the master apparatus and the slave apparatus. The master apparatus includes a first storage unit for storing data, an edit-control information transmission control unit for transmitting, to the slave apparatus via the communication unit, edit-control information which is required to perform an edit and reproduction operation using, as an edit material, edit object data containing at least one unit of data stored on the first storage unit, and a synchronization unit for synchronizing a reproduction output of the master apparatus with a reproduction output of the slave apparatus in reproduction sequence, the reproduction output of the master apparatus being output by performing the edit and reproduction operation using the edit object data as the edit material stored on the first storage unit based on edit-control information identical to the edit-control information transmitted by the edit-control information transmission control unit, and the reproduction output of the slave apparatus being output by performing the edit and reproduction operation using the edit object data as the edit material stored on a second storage unit, based on the edit-control information received from the edit-control information transmission control unit. The slave apparatus includes the second storage unit.

In accordance with another embodiment of the present invention, a reproducing apparatus includes a communication unit for performing, via a predetermined communication network, communications with another reproducing apparatus serving as a slave apparatus, a first storage unit for storing data, an edit-control information transmission control unit for transmitting, to the other reproducing apparatus via the communication unit, edit-control information which is required to perform an edit and reproduction operation using, as an edit material, edit object data containing at least one unit of data stored on the first storage unit, an edit and reproducing unit for providing a reproduction output by performing the edit and reproducing operation using as the edit material the edit object data stored on the first storage unit based on edit-control information identical to the edit-control information transmitted by the edit-control information transmission control unit, and a synchronization unit for synchronizing the reproduction output of the edit and reproducing unit with a reproduction output of the other apparatus in reproduction sequence, the reproduction output of the other reproducing apparatus being output by performing the edit and reproduction operation using the edit object data as the edit material stored on a second storage unit of the other reproducing apparatus,.based on the edit-control information received from the edit-control information transmission control unit.

In accordance with yet another embodiment of the present invention, a reproducing apparatus includes a communication unit for performing, via a predetermined communication network, communications with another reproducing apparatus serving as a master apparatus, a second storage unit for storing data, an edit and reproducing unit for providing a reproduction output by performing an edit and reproducing operation using, as an edit material, edit object data recorded on the second storage unit and specified by edit-control information, the edit-control information being received from the other reproducing apparatus by the communication unit and being required to perform the edit and reproducing operation, and a synchronization unit for synchronizing the reproduction output of the edit and reproducing unit with a reproduction output of the other apparatus in reproduction sequence, the reproduction output of the other reproducing apparatus being output by performing the edit and reproduction operation, using the edit object data as the edit material stored on a first storage unit of the other reproducing apparatus, based on edit-control information identical to the edit-control information transmitted by the other reproducing apparatus.

In each of the above embodiments, the master apparatus transmits to the slave apparatus the edit-control information that is used to provide the reproduction output by editing the edit object data stored the master apparatus. The reproduction output of the master apparatus and the reproduction output of the slave apparatus are controlled to be synchronized in reproduction sequence. The reproduction output of the master apparatus is obtained by editing the edit object data as the material based on the same edit-control information as the edit-control information transmitted by the master apparatus. The reproduction output of the slave apparatus is obtained by editing the edit object data as the material based on the edit-control information received by the slave apparatus. More specifically, the same data stored on the master apparatus and the slave apparatus is reproduced in synchronization. The reproduced data on the two apparatuses has undergone the same editing.

In one embodiment of the present invention, a reproducing system includes a transmitting apparatus, at least one receiving and reproducing apparatus, and a communication unit for performing communications via a predetermined communication network between the transmitting apparatus and the receiving and reproducing apparatus. The transmitting apparatus includes an edit-control information generating unit for generating edit-control information required to execute an edit and reproducing operation using predetermined edit object data as an edit material, an edit-control information transmission control unit for transmitting the edit-control information to the receiving and reproducing apparatus via the communication unit. The receiving and reproducing apparatus includes a storage unit for storing data, and an edit and reproducing unit for providing a reproduction output by performing an edit and reproducing operation using the edit object data stored on the storage unit as an edit material, based on the edit-control information received from the edit-control information transmission control unit.

In another embodiment of the present invention, a receiving and reproducing apparatus includes a communication unit for performing communications with a transmitting apparatus via a predetermined communication network, a storage unit for storing data, and an edit and reproducing unit for providing a reproduction output by performing an edit and reproducing operation using edit object data as an edit material stored on the storage unit, based on edit-control information transmitted from the transmitting apparatus, received by the communication unit, and required to execute the edit and reproducing operation on the edit object data.

In each of the above-referenced embodiments, the edit-control information generated on the transmitting apparatus is transmitted to the receiving and reproducing apparatus. The edit-control information is intended to be used for the editing of data stored on the receiving and reproducing apparatus. In accordance with the received edit-control information, the receiving and reproducing apparatus performs the editing operation on the data stored thereon, and provides the reproduction output.

When the stored data is reproduced in synchronization on a plurality of apparatuses (including the master apparatus, the slave apparatus, and the reproducing apparatus), the reproduction output that has undergone the same edit is provided. Since the synchronized reproduced data is edited, the system provides a Quality of amusement higher than when the original content is simply reproduced in synchronization. Since any redundant portion may be removed in the editing process, viewing efficiency is increased.

In accordance with embodiments of the present invention, data stored on the receiving and reproducing apparatus is edited in accordance with the received edit-control information, and then output in reproduction. For example, a user of this receiving and reproducing apparatus can efficiently view the content having a higher amusement level than the original content.

### BRIEF DESCRIPTION OF THE DRAWINGS

FIG. 1 is a configuration diagram of a system of one embodiment of the present invention;

FIG. 2 is a functional block diagram illustrating functions performed by an AV content recording and reproducing apparatus of one embodiment of the present invention;

FIG. 3 is a block diagram illustrating a hardware structure of the AV content recording and reproducing apparatus of the embodiment of the present invention;

FIG. 4 illustrates a process for synchronized video recording;

FIG. 5 diagrammatically illustrates an edit content;

FIG. 6 illustrates a described content of edit-control information corresponding to the edit content of FIG. 5;

FIG. 7 illustrates a process of an edit content synchronized reproduction; and

FIG. 8 illustrates a system configuration of one embodiment of the present invention.

### DESCRIPTION OF THE PREFERRED EMBODIMENTS

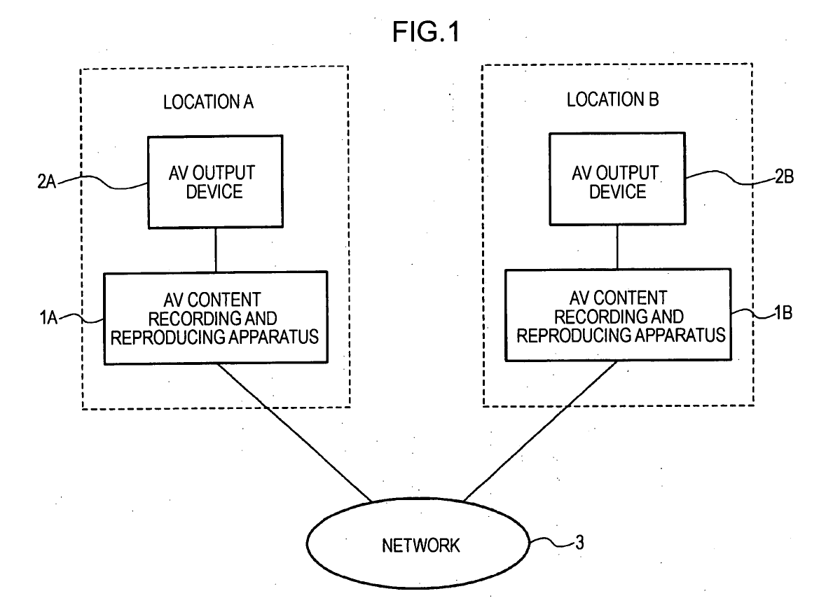

FIG. 1 illustrates a system architecture of one embodiment of the present invention.

As shown in FIG. 1, AV content recording and reproducing apparatuses 1A and 1B are respectively installed in locations A and B physically separated from each other. If there is no need for discriminating between the AV content recording and reproducing apparatus 1A installed in the location A and the AV content recording and reproducing apparatus 1B installed in the location B, each of the two apparatuses is referred to as an AV content recording and reproducing apparatus 1.

The AV content recording and reproducing apparatus 1 corresponds to each of a master apparatus, a slave apparatus, a reproducing apparatus, and a receiving and reproducing apparatus in the context of the present invention. The AV content recording and reproducing apparatus 1 records audio and video (AV) information as content data, and reproduces the recorded content data.

As will be described later, the AV content recording and reproducing apparatus 1 of one embodiment of the present invention selects and receives a television broadcast program and records received audio and video information of the program as the content data.

The AV content recording and reproducing apparatus 1 outputs an audio and video signal in a predetermined form by reproducing the content data. As shown in FIG. 1, the audio and video signals output from the AV content recording and reproducing apparatuses 1A and 1B are respectively output to audio/video output devices 2A and 2B. Each of the audio/video output devices 2A and 2B includes a predetermined display and an audio signal output circuit. In response to input audio and video signals, each of the audio/video output devices 2A and 2B outputs a video signal and an audio signal to one of a loudspeaker and a headphone terminal. The content data thus reproduced by the AV content recording and reproducing apparatus 1 is output in a state viewable and audible from the audio/video output devices 2A and 2B.

The AV content recording and reproducing apparatus 1 has a function of being connected to a network 3 such as the Internet or a local-area network (LAN). As shown in FIG. 1, the AV content recording and reproducing apparatuses 1A and 1B, each connected to the network 3, can mutually communicate with each other via the network 3.

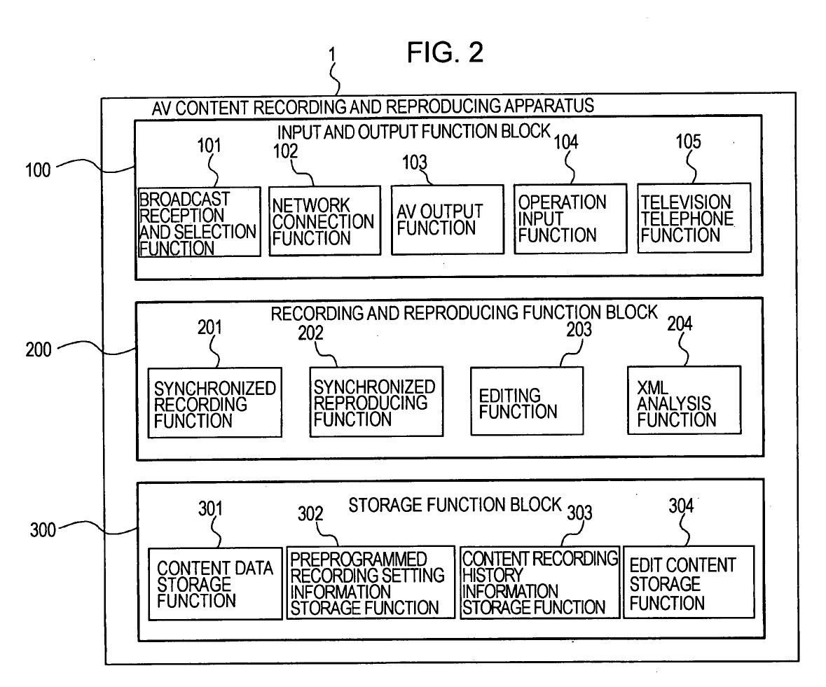

FIG. 2 is a functional block diagram of the AV content recording and reproducing apparatus 1 that is embodied by implementing hardware and software architectures.

The functions of the AV content recording and reproducing apparatus 1 are chiefly divided into an input and output function block 100, a recording and reproducing function block 200, and a storage function block 300.

The input and output function block 100 is related to inputting and outputting of data and signals with an external device and an external source. The input and output function block 100 includes a broadcast reception and selection function 101, a network connection function 102, an AV output function 103, and an operation input function 104 and a television telephone function 105.

The broadcast reception and selection function 101 selects and receives a television broadcast program and outputs audio and video information of the television broadcast program.

The network connection function 102 establishes a link with the network 3 to perform data communications with another communication device.

The AV output function 103 outputs a video and an audio in viewable and audible state in response to the audio and video information selected and received by the broadcast reception and selection function 101, the audio and video information acquired by the broadcast reception and selection function 101 via the network 3, and audio and video information reproduced from a storage device with a reproducing function to be discussed later. The AV output function 103 of the present embodiment outputs an audio and video signal (audio and video data) in a predetermined format. Finally, the audio/video output device 2 outputs an audio and a video in a viewable and audible state.

The operation input function 104 receives a variety of operation inputs, and transfers, to a predetermined functional block, operation information indicating the meaning of each operation input. More specifically, the operation input function 104 serves as an interface receiving an operation input onto the AV content recording and reproducing apparatus 1.

With the television telephone function 105, the AV content recording and reproducing apparatus 1 can exchange television telephone voice and captured video with another AV content recording and reproducing apparatus 1 (any apparatus provided with a television telephone function other than the AV content recording and reproducing apparatus 1) via the network 3. A user of the AV content recording and reproducing apparatus 1 can thus communicate with other users over television telephone.

The recording and reproducing function block 200 performs predetermined operations to record and/or reproduce content data composed of the audio and video information. The recording and reproducing function block 200 includes a synchronized recording function 201, a synchronized reproducing function 202, an editing function 203, and an XML analysis function 204.

The synchronized recording function 201 performs a preprogrammed recording operation to record in a preprogrammed manner a program selected and received by the broadcast reception and selection function 101. For example, a program to be preprogram-recorded is designated and set. In response to the preprogrammed recording setting transferred by the operation input function 104, the AV content recording and reproducing apparatus 1 performs a preprogrammed recording operation. The synchronized recording function 201 of the present embodiment then allows another AV content recording and reproducing apparatus 1 communicable with own apparatus via the network 3 to perform the same preprogrammed recording operation as own apparatus, in other words, allows the other AV content recording and reproducing apparatus 1 to perform the same preprogrammed recording operation in synchronization with own apparatus.

The synchronized reproducing function 202 causes the content data stored on own apparatus and the content data stored on the other AV content recording and reproducing apparatus 1 connected to own apparatus via the network 3 to be reproduced on the respective apparatuses in synchronization. In accordance with the present embodiment, the synchronized reproducing function 202 not only reproduces the content data shared by own apparatus and the other AV content recording and reproducing apparatus 1 in the original form thereof in synchronization, but also permits content data, edited by the editing function 203 to be discussed later, to be reproduced in synchronization.

The editing function 203 performs a process so-called authoring. The editing function 203 generates reproduction control information in response to the operation information transferred from the operation input function 104 when the user enters an edit operation input. The stored original content data is thus edited in accordance with the reproduction control information.

In accordance with the present embodiment, the original content data is not directly manipulated and not modified in the edit operation. Instead, a script, i.e., control information specifying the form of reproduction output of the audio and video data is used. The control information is the edit-control information generated by the editing function 203. In accordance with the present embodiment, extensible markup language (EML) as one of markup languages is used as the edit-control information.

The XML analysis function 204 analyzes the XML edit-control information, and performs a process in accordance with the script. With this function, an edit and reproduction operation is performed. The XML analysis function 204 performs a predetermined signal process and a data process on the audio and video information (signals) so that the audio and video in the reproduction output form responsive to the command indicated by the edit-control information are obtained from the original content data.

If information specifying the edit content is stored in a format different from XML, the XML analysis function 204 reads the information, and compiles the information into edit-control information in XML format.

The storage function block 300 includes functions for storing and managing a variety of units of data and information. More specifically, the storage function block 300 includes a content data storage function 301, a preprogrammed recording setting information storage function 302, a content recording history information storage function 303, and an edit content storage function 304.

The content data storage function 301 stores and manages the content data (audio and video information) acquired through the broadcast reception and selection function 101 and the network connection function 102.

The preprogrammed recording setting information storage function 302 generates preprogrammed recording setting information in response to an operation for a preprogrammed recording setting input received by the operation input function 104. The preprogrammed recording setting information specifies a channel and a time slot for preprogrammed recording. The preprogrammed recording setting information storage function 302 stores the preprogrammed recording setting information.

In accordance with the content data stored and managed by the content data storage function 301, the content recording history information storage function 303 generates content recording history information indicating history of content data stored (recorded) so far. The content recording history information storage function 303 stores the generated content recording history information.

The edit content storage function 304 stores information indicating edit results obtained through the authoring process of the editing function 203. The information indicating the edit results may be stored as the edit-control information in XML format or may be stored as a database in a predetermined format to improve storage. efficiency. In the case of the latter case, the information indicating the edit results may be converted into edit-control information in the XML format using the compile function of the XML analysis function 204.

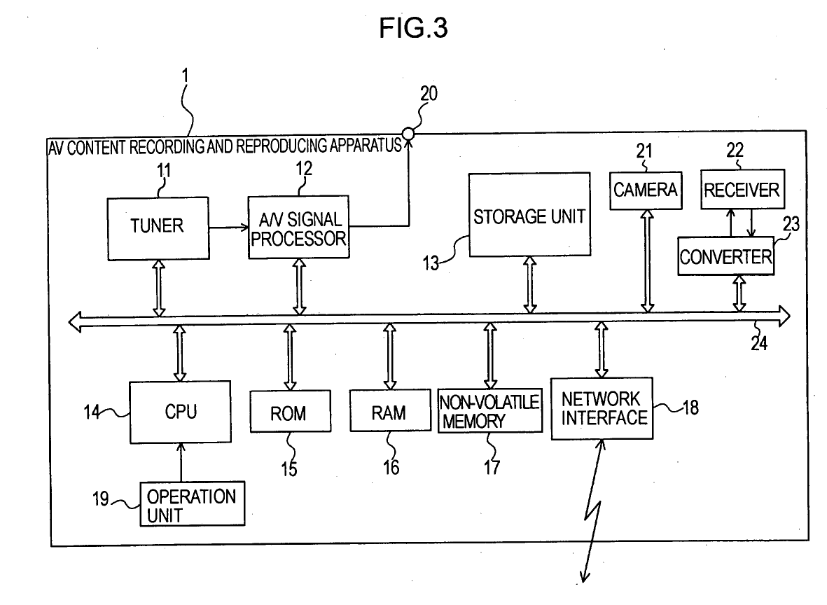

FIG. 3 is a block diagram illustrating a hardware architecture of the AV content recording and reproducing apparatus 1.

A tuner 11 outputs to an A/V signal processor 12 the audio and video data obtained as a result of selecting and receiving television broadcast signals. The selection and reception operation of the tuner 11 are controlled by a CPU 14. The broadcast reception and selection function 101 of FIG. 2 is thus performed. The television broadcast system of the tuner 11 includes but is not limited to digital broadcasting. The digital broadcast may be one of terrestrial broadcasting and satellite broadcasting.

The A/V signal processor 12 performs a predetermined signal process on the audio and video data. The audio and video data output from the tuner 11 is the edit-control information that is encoded (compressed) using a predetermined compression method. When the audio and video signals are received from the tuner 11, the A/V signal processor 12 performs the predetermined decoding process (decompression process) on the input audio and video data, thereby converting the input audio and video data into a predetermined audio and video signal. The resulting audio and video signal is then output from an audio and video output terminal 20. By connecting the audio and video output terminal 20 to an audio and video input terminal of the audio/video output device 2 of FIG. 1, the audio and video of the television program are output from the audio/video output device 2. The function of outputting the audio and video from the audio and video output terminal 20 corresponds to the AV output function 103 of FIG. 2.

Under the control of the CPU 14, the A/V signal processor 12 performs a recording and encoding process compatible with a recording format of a storage unit 13 onto the audio and video data input from the tuner 11, and then transfers the resulting audio and video data to the storage unit 13 via a bus 24. The storage unit 13 stores onto an internal storage medium thereof the incoming audio and video data in a manner such that the audio and video data is managed as content data by file. The AV content recording and reproducing apparatus 1 of the present embodiment has a recording function to record information of audio and video of a selected and received television broadcast program. Namely, the content data storage function 301 is performed.

The storage unit 13 storing and managing a variety of data including the audio and video data includes a predetermined type of storage medium and a drive thereof. The type of the storage medium of the storage unit 13 is not limited to any particular one. Since a content to be stored onto the storage medium contains an audio and a video as a moving image, the storage medium needs to have a relatively large memory size. A hard disk drive (HDD) is thus employed for the storage unit 13. The storage medium loaded onto the storage unit 13 may be one fixed in the AV content recording and reproducing apparatus 1 or may be a removable one loaded to and unloaded from the AV content recording and reproducing apparatus 1.

The audio and video content data stored on the storage unit 13 may be read and reproduced under the control of the CPU 14. The CPU 14 reads a content data file of audio and video from the storage unit 13, and transfers the read content data file to the A/V signal processor 12 via the bus 24. As previously discussed, the A/V signal processor 12 performs the decoding process on the input audio and video data, and then outputs the resulting audio and video data from the audio and video output terminal 20. The AV content recording and reproducing apparatus 1 thus has the reproduction function of providing a reproduction output of the audio and video data stored on the storage unit 13. Through the synchronized reproducing function 202 of FIG. 2, the edited content data file can be reproduced in synchronization with the other AV content recording and reproducing apparatus 1 connected to own apparatus via the network 3. The synchronized reproduction will be described later.

A network interface 18 is a hardware element for communication with the other AV content recording and reproducing apparatus 1 via the network 3. To transmit data via the network 3, the AV content recording and reproducing apparatus 1 packetizes the data in accordance with a communication protocol compatible with the network 3, for example. Upon receiving data via the network 3, the AV content recording and reproducing apparatus 1 restores the original data by depacketizing the received data, and transfers the restored data to the CPU 14 via the bus 24. This operation corresponds to the network connection function 102 of FIG. 2.

The AV content recording and reproducing apparatus 1 includes a camera 21, a receiver 22 and a converter 23 to perform the television telephone function 105. The camera 21 converts an image signal, captured during photographing, into video signal data and outputs the video signal data. When a user uses television telephone, the camera 21 is mainly used to capture the image of the user's own face. The video signal data output from the camera 21 is transferred to the network interface 18 via the bus 24 under the control of the CPU 14. The video signal data is transmitted to an apparatus as a communication partner together with audio signal data of voice to be discussed later.

The receiver 22 acquires an audio signal by picking up a voice of a user. The audio signal is converted into the audio signal data by the converter 23. As discussed above, the audio signal data is transmitted to the partner apparatus from the network interface 18 via the network 3.

The video signal data for television telephone and the audio signal data of the voice of the user transmitted from the partner apparatus via the network 3 are received by the network interface 18. The video signal data received by the network interface 18 is transferred to the A/V signal processor 12 under the control of the CPU 14. The video signal data is then processed by the A/V signal processor 12 and the processed signal is then output from the audio and video output terminal 20. From the audio/video output device 2, the user can view a video that is captured on the television telephone on the partner side. The audio signal data received by the network interface 18 is also transferred to the A/V signal processor 12 for processing. The processed audio signal is then output from the audio and video output terminal 20. From the audio/video output device 2, the user can listen to the received voice of another user on the television telephone.

By executing a program stored on a read-only memory (ROM) 15 (or the storage unit 13), the CPU 14 performs a. variety of control processes on the AV content recording and reproducing apparatus 1. The ROM 15 stores a variety of pieces of set information in addition to the program to be executed by the CPU 14. The CPU 14 uses a random-access memory (RAM) 16 as a working memory area.

The program to be executed by the CPU 14 may be written onto the ROM 15 (or the storage unit 13) at a manufacturing process before being shipped from the factory of the AV content recording and reproducing apparatus 1. Since the storage unit 13 permits a program stored thereon to be updated, data of the program may be downloaded and installed onto the storage unit 13 via the network interface 18 for updating. Alternatively, the program stored on a predetermined removal storage medium may be written from the medium to the storage unit 13. A drive receiving a removable storage medium may be mounted in the AV content recording and reproducing apparatus 1 although such a drive is not illustrated in FIG. 3. The data of the program read from the removable storage medium on another information processing apparatus may be transmitted to the AV content recording and reproducing apparatus 1 via the network 3.

A non-volatile memory 17 is of a data programmable type and continuously stores data even in the event of power interruptions. The non-volatile memory 17 is one of an electrically erasable and programmable read-only memory (EEPROM) and a flash memory. In accordance with the present embodiment, the non-volatile memory 17 stores a variety of pieces of information that are rewritten as necessary. The non-volatile memory 17 may also store the program to be executed by the CPU 14.

The operation unit 19 collectively includes a variety of controls arranged on the AV content recording and reproducing apparatus 1 and a unit for generating operation information signals in response to an operation performed on each of the controls and outputting the operation information signals to the CPU 14. The operation unit 19 may include a remote controller with predetermined controls and a reception processor for receiving the signals from the remote controller and then outputs the received signals as the operation information to the CPU 14. The CPU 14 performs the predetermined control process in response to the operation information signal.

The AV content recording and reproducing apparatus 1 of the present embodiment includes a preprogrammed recording function. A program for the preprogrammed recording function is also stored on the ROM 15. The CPU 14 executes the program for the preprogrammed recording function. In response to the operation for the preprogrammed recording setting on the operation unit 19, the preprogrammed recording setting information for specifying the preprogrammed recording content is generated, and then stored on the non-volatile memory 17, for example. This operation corresponds to the preprogrammed recording setting information storage function 302. The preprogrammed recording setting information may include a channel of a program to be preprogram recorded, recording start date and time, recording end date and time, program name to be preprogram recorded, etc. In digital broadcasting, in accordance with the Association of Radio Industries and Businesses (ARIB) standard, a broadcast program content or an electronic program guide is transmitted together with a program name and category information in addition to a network identification (ID), a service ID, and an event ID for identifying the channel and the program. The preprogrammed recording setting information may include these items.

As previously discussed with reference to FIG. 2, the AV content recording and reproducing apparatus 1 of the present embodiment includes the synchronized recording function 201 to preprogram the recording of the same television program with the other AV content recording and reproducing apparatus 1 connected to own apparatus via the network 3. The synchronized recording function 201 will be described later.

The CPU 14 performs the editing function 203 and the XML analysis function 204 of FIG. 2 by executing the program thereof.

The editing function 203 is provided with the authoring program for editing the audio and video information. The editing function 203 is thus performed when the CPU 14 executes that program. The edit content may be stored on the non-volatile memory 17 (or the storage unit 13) in a predetermined form. This storage function is illustrated as the edit content storage function 304 of FIG. 2.

The XML analysis function 204 is performed when the CPU 14 executes the program for XML analysis process and compiling process. For example, the CPU 14 controls the A/V signal processor 12 to perform a signal process on the audio and video data as an edit object so that a reproduction output form responsive to control content acquired as a result of analysis of a script is obtained.

Depending on the program of the CPU 14, the editing function 203 of FIG. 2 is also performed. To this end, the CPU 14 acquires a list of content data stored so far on the storage unit 13, and then stores and manages the list in a predetermined form on the non-volatile memory 17. When the list acquisition is performed for the preprogrammed recording operation, required information relating to the program to be recorded (such as broadcasting date and time, broadcasting channel, program title, and category of the program) is acquired. These pieces of information are used to generate information unit on a per recording program. A set of information units is managed in list structure.

The synchronized reproduction of the content data edited in accordance with the present embodiment is discussed below. In the synchronized reproduction, the same content data is stored by the storage units 13 of a plurality of AV content recording and reproducing apparatuses 1 connected to each other via the network 3, and then reproduced in synchronization by the AV content recording and reproducing apparatuses 1. The content data that has been edited is also reproduced in synchronization.

Since the same content data is shared by the storage units 13 of a plurality of AV content recording and reproducing apparatuses 1, an AV content recording and reproducing apparatus 1 as a master apparatus performs the preprogrammed recording operation in accordance with the preprogrammed recording setting information in accordance with the synchronized recording function 201. Another AV content recording and reproducing apparatus 1 as a slave apparatus also performs the preprogrammed recording operation in the same preprogrammed recording setting information. The AV content recording and reproducing apparatuses 1 store the content data of the same television broadcast program on the respective storage units 13.

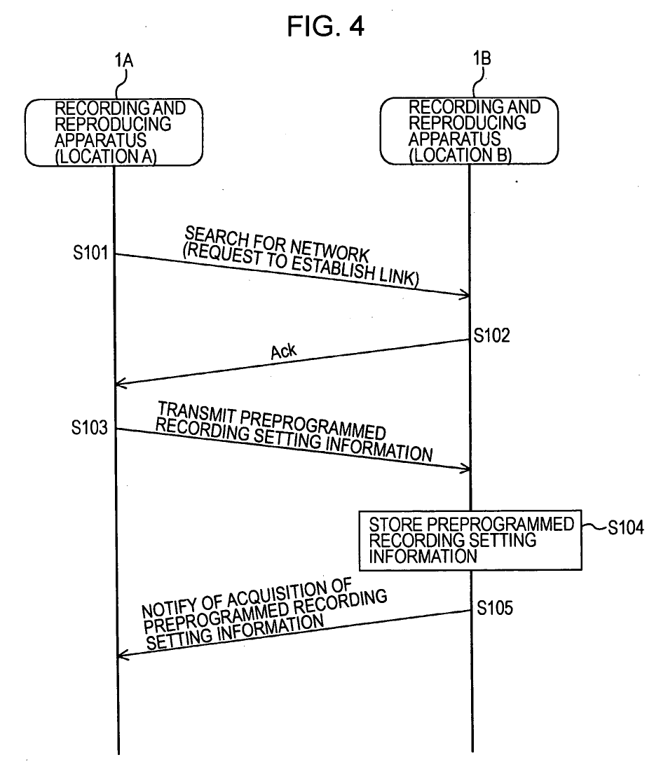

FIG. 4 illustrates a process for synchronized recording performed among the plurality of AV content recording and reproducing apparatuses 1. This process corresponds to the process performed between the AV content recording and reproducing apparatuses 1A and 1B of FIG. 1. The AV content recording and reproducing apparatus 1A at the location A serves as a master apparatus, and the AV content recording and reproducing apparatus 1B at the location B serves as a slave apparatus. The CPUs 14 of the AV content recording and reproducing apparatuses 1A and 1B perform a process as a master side and a process as a slave side, respectively, corresponding to the synchronized recording function 201.

A user has performed the preprogrammed recording setting on the AV content recording and reproducing apparatus 1A, and the AV content recording and reproducing apparatus 1A currently stores the preprogrammed recording setting information. The user of the AV content recording and reproducing apparatus 1A may want the AV content recording and reproducing apparatus 1B to record and share the program to be recorded in accordance with the preprogrammed recording setting information.

The user of the AV content recording and reproducing apparatus 1A enters a predetermined command to the operation unit 19, thereby commanding the AV content recording and reproducing apparatus 1A to transmit the preprogrammed recording setting information to the AV content recording and reproducing apparatus 1B. In step S101, the AV content recording and reproducing apparatus 1A searches for an address of the AV content recording and reproducing apparatus 1B as a destination (such as an IP address or a MAC address in TCP/IP), and issues to the AV content recording and reproducing apparatus 1B a request to establish a link via the network 3.

In response to the request, the AV content recording and reproducing apparatus 1B generates acknowledge (Ack) in step S102, thereby transmitting the Ack to the AV content recording and reproducing apparatus 1A unless the network 3 is occupied by another device or unless the AV content recording and reproducing apparatus 1B is in a busy state for performing another process.

The AV content recording and reproducing apparatus 1A waits on standby for the reception of the Ack responsive to the link establishment request subsequent to the network search process in step S101. Upon receiving the Ack, the AV content recording and reproducing apparatus 1A reads in step S103 from the non-volatile memory 17 the preprogrammed recording setting information specified by the preceding operation input, and then transmits the preprogrammed recording setting information from the network interface 18 via the network 3.

Upon receiving the preprogrammed recording setting information, the AV content recording and reproducing apparatus 1B stores the received preprogrammed recording setting information on the storage unit 13 thereof in step S104. In step S105, in reply to the reception of the preprogrammed recording setting information, the AV content recording and reproducing apparatus 1B transmits to the AV content recording and reproducing apparatus 1A a notification that the preprogrammed recording setting information has been successfully acquired. Upon receiving the notification, the AV content recording and reproducing apparatus 1A recognizes that the AV content recording and reproducing apparatus 1B has successfully acquired the preprogrammed recording setting information. The transaction for the transmission of the preprogrammed recording setting information is thus completed.

Subsequent to the completion of the process of FIG. 4, the AV content recording and reproducing apparatuses 1A and 1B store the preprogrammed recording setting information for the common command for preprogrammed recording of the same television broadcast program.

As previously discussed, the AV content recording and reproducing apparatus 1 performs the preprogrammed recording operation in accordance with the stored preprogrammed recording setting information. After each of the AV content recording and reproducing apparatuses 1A and 1B performs the preprogrammed recording operation in accordance with the common preprogrammed recording setting information, the storage units 13 of the AV content recording and reproducing apparatuses 1A and 1B store the same television broadcast program. The AV content recording and reproducing apparatuses 1A and 1B thus share the same content data.

In accordance with the present embodiment, the method of storing the same content data on the storage units 13 of the plurality of AV content recording and reproducing apparatuses 1 is not limited to the synchronized recording of FIG. 4. In the simplest method, the content data to be commonly shared among the plurality of AV content recording and reproducing apparatuses 1 is stored on a removable storage medium, and the content data is then stored from the removable storage medium onto the storage unit 13 of each of the plurality of AV content recording and reproducing apparatuses 1.

Alternatively, the content data in a file may be transmitted from one AV content recording and reproducing apparatus 1 to another AV content recording and reproducing apparatus 1 for storage via the network 3.

In contrast to these methods, the method of FIG. 4 for the content data of the television broadcast program is free from a manual operation such as handing in person a removable storage medium over to a user of another AV content recording and reproducing apparatus 1. The content data herein contains video information of moving image, and has a relatively large data size as one content data file. Exchanging such a data file over the network 3 excessively overloads the network 3 in terms of traffic. Substantial time may be required to complete the transmission, inconveniencing the user of the AV content recording and reproducing apparatus 1. With the method of FIG. 4, only the preprogrammed recording setting information is transmitted and received via the network 3. The data size of the preprogrammed recording setting information is small enough to be free from the problem of overloading the traffic of the network 3 and time required to complete the transmission of the preprogrammed recording setting information is very short.

During the synchronized recording of FIG. 4, the content data of the television broadcast program is now stored on the storage unit 13 of each of the two AV content recording and reproducing apparatuses 1A and 1B. The user of the AV content recording and reproducing apparatus 1A may want to edit the content data of the television broadcast program and enjoy the edited content data with a user of the AV content recording and reproducing apparatus 1B in synchronization.

In the following discussion, a reproduction output obtained as a result of editing is referred to as an edited content and an edit material required to produce the edit content is referred to original content data.

The user of the AV content recording and reproducing apparatus 1A edits the original content data stored on the storage unit 13 of the AV content recording and reproducing apparatus 1. The editing function 203 of FIG. 2 is thus used. For example, the user then operates the AV content recording and reproducing apparatus 1A for editing. In other words, the user performs a variety of edit processes on the original content data within the function range covered by the editing function 203.

It should be noted that the editing of the present embodiment is performed so that the output form of the original content data is changed in response to a control command (edit-control information) described in XML. The edited content is produced based on the original content data and the edit-control information. The original content data itself is not updated, and maintains the original form thereof. The edited content may be produced based on a plurality of pieces of original content data as an edit material.

As the edit results, the edit-control information or the edit content is stored on the non-volatile memory 17 in a database form through the edit content storage function 304.

When editing is performed through the editing function 203, a user interface program is arranged to output a graphic user interface (GUI) screen for editing and perform an operation on the operation unit 19 as an operation to be performed on the GUI screen. The user can thus easily perform the editing operation. In the case of the AV content recording and reproducing apparatus 1 of FIG. 3., the a video signal of the GUI screen is output from the audio and video output terminal 20, and the GUI screen is displayed on the audio/video output device 2.

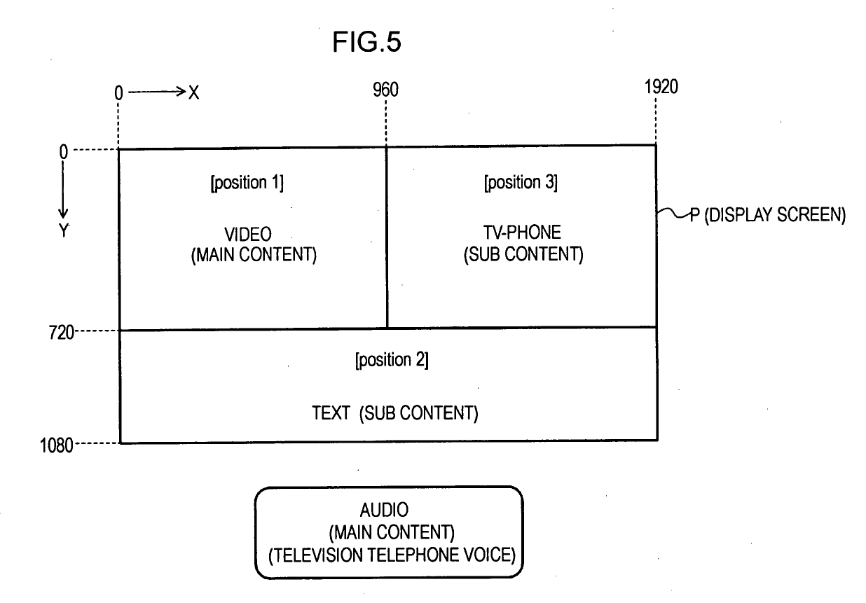

FIG. 5 illustrates a concept of the edit results of the contents.

A display screen P appears as shown in FIG. 5 when the edited content is reproduced. The display screen P includes a display area of 1920 rows and 1080 columns of pixels. With respect to the top left corner of the display area where the long side and the short side of the display area intersect each other, X coordinates are horizontally leftward graduated within a range from 0 to 1920, and Y coordinates are vertically downward graduated within a range from 0 to 1080.

The display area of the display screen P is segmented into position 1, position 2, and position 3. The position 1 is defined by an area of X coordinates 0-960 and Y coordinates 0-720, the position 2 is defined by an area of X coordinates 0-1920 and Y coordinates 0-1080.

The display area of the position 1 is assigned as an area to display a content defined as “video” by the edit-control information. The “video” becomes the original content data stored on the storage unit 13. One of the purposes of the editing of the original content data is to display an image of the original content data on the area of the position 1. To display the image of the original content data on the area of the position 1, a description defining the display of the image of the original content data is contained in the edit-control information in the display screen P. It is perfectly acceptable to remove part of the original content data, and add special effects on the image of the original content data.

The original content data becomes the main content of the edited content in the display screen P, and is thus referred to as the main content.

The display area of the position 2 is assigned as an area to display a video of a content defined as a “text.” The editing function 203 permits text information to be attached to a display output in the edit operation. The “text” becomes the text information attached in the edit operation. The position 2 becomes an area where the text information as a content defined as the “text” is displayed as actual characters.

The display area of the position 3 is assigned as an area to display a video content defined as “TV-phone”. With the television telephone function 105 of the present embodiment, the users of the AV content recording and reproducing apparatuses 1A and 1B can communicate with each other using the television telephone function 105 when the AV content recording and reproducing apparatuses.1A and 1B reproduce the edited content in synchronization. The audio and video are then output. The TV-phone area serves as an area where the image of a communication partner of television telephone is displayed.

The image of the text displayed on the text area at the position 2 and the image of the text or the image of the television phone displayed on the TV-phone area at the position 3 are handled as a sub content if the original content data displayed on the video area at the position 1 is treated as the main content.

An “audio” block is arranged below the display screen P. As the edited content, an audio is also output along with the video displayed as the display screen P. In addition to the audio corresponding to the main content, an audio of the television telephone may be output as a sub content. If a sound effect is inserted in the edit operation, such a sound effect may also be output.

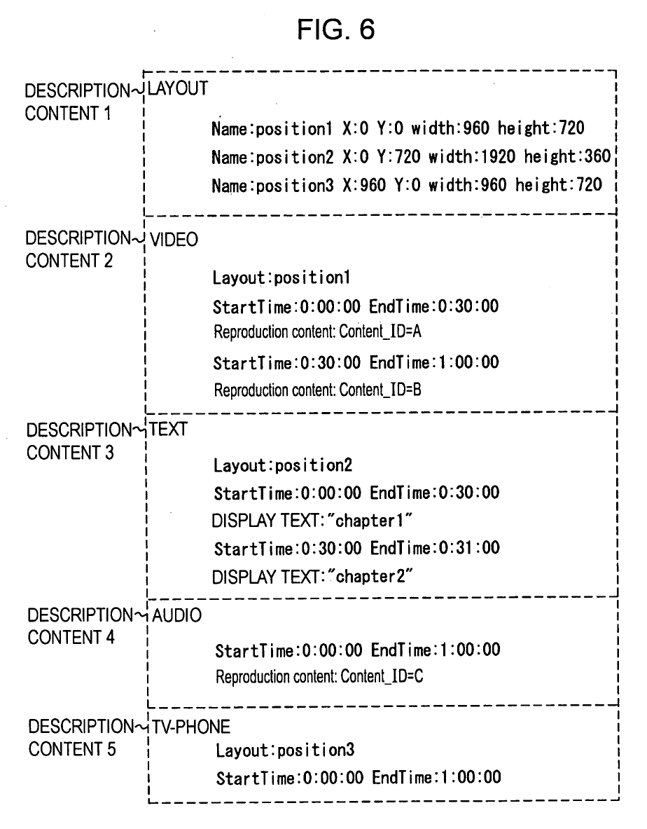

FIG. 6 illustrates a content example of the edit-control information of FIG. 5. The content is described in a script using XML tag or the like.

As shown in FIG. 6, the three display areas at the position 1, the position 2, and the position 3 of FIG. 5 are indicated in accordance with the layout definition of a description content 1.

In a description content 2 for the video, a definition “layout: position 1” specifies that the video content be displayed in the position 1. A combination of information units of StartTime, EndTime, and information specifying a reproduction content specifies which content data stored on the storage unit 13 is to be reproduced in what reproduction time. In this case, as main content data, content data of Content ID=A is reproduced for a duration of time 0:00:000-0:30:00, and then content data of Content ID=B is reproduced for a duration of time 0:30:00-1:00:00. The content data having the same content is assigned a single common content ID. As will be discussed later, the same content data is searched for on a plurality of different AV content recording and reproducing apparatuses 1 based on the Content ID in the synchronized reproduction. As a result, the same content data is reproduced on the plurality of different AV content recording and reproducing apparatuses 1.

In accordance with a description content 3 for the text, a definition “Layout: position 2” specifies that the text content be displayed in the position 2. A combination of information units of StartTime, EndTime, and information specifying a reproduction content specifies which content data stored on the storage unit 13 is to be reproduced in what reproduction time. In this case, as main content data, a video of Content ID=A is reproduced for a duration of time 0:00:000-0:30:00, and then a video of Content ID=B is reproduced for a duration of time 0:30:00-1:00:00. The content data having the same content is assigned a single common content ID. As will be discussed later, the same content data is searched for on a plurality of different AV content recording and reproducing apparatuses 1 based on the Content ID in the synchronized reproduction. As a result, the same content data is reproduced on the plurality of different AV content recording and reproducing apparatuses 1.

In accordance with a description content 4 for the audio, content data of an audio to be reproduced and reproduction output time thereof are specified. An audio of the content data identified by Content ID=C is reproduced within a duration of time 0:00:00-1:00:00. In this case, two pieces of image content data identified by Content ID=A, B are successively output while the audio of the content data identified by Content ID=C is reproduced. If the audio is defined so that the audio of the main content is reproduced in synchronization with the video of the main content, the audio and the video of the main content are output in synchronization.

The voice of the television telephone is typically output in accordance with the exchange of the audio data of an actual conversation through the television telephone function 105 rather than being controlled by the edit-control information.

In the definition of TV-Phone of a description content 5, a definition “Layout: position 3” specifies that the image of the television telephone be displayed at the position 3.

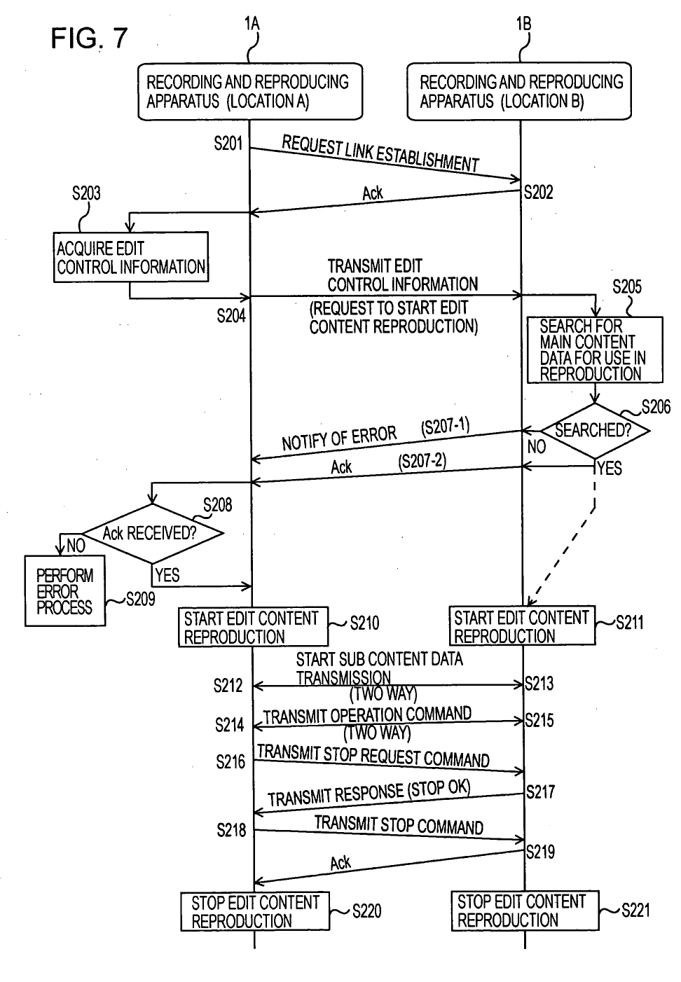

FIG. 7 illustrates the synchronized reproduction process of the edited content performed by the AV content recording and reproducing apparatuses 1A and 1B. In this process, the AV content recording and reproducing apparatus 1A serves as a master apparatus while the AV content recording and reproducing apparatus 1B serves as a slave apparatus. The CPUs 14 of the AV content recording and reproducing apparatuses 1A and 1B respectively perform a process on the master side and a process on the slave side, each process as the synchronized reproducing function 202.

When the process of FIG. 7 starts, the edited content to be reproduced has already been completed. The data of the edited content is already stored on the non-volatile memory 17 of the AV content recording and reproducing apparatus 1A.

When the user of the AV content recording and reproducing apparatus 1A reproduces a given edited content, the edited content to be reproduced and another AV content recording and reproducing apparatus 1 that is to perform the synchronized reproduction operation are specified by entering a predetermined operation input to the operation unit 19. Then, a command to start the synchronized reproduction is entered. The AV content recording and reproducing apparatus 1B is specified as the other AV content recording and reproducing apparatus 1 that is to perform the synchronized reproduction operation. In step S201, the AV content recording and reproducing apparatus 1 searches the network for the AV content recording and reproducing apparatus 1B, and issues a request to establish a link.

In response to the request to establish the link, the AV content recording and reproducing apparatus 1B returns Ack in step S202. Upon receiving Ack, the AV content recording and reproducing apparatus 1A recognizes that the AV content recording and reproducing apparatus 1A can perform the synchronized reproduction process with the partner AV content recording and reproducing apparatus 1B.

The AV content recording and reproducing apparatus 1A having received the Ack acquires edit-control information for reproducing a current edited content in step S203. If edit content information is the XML edit-control information, the edit-control information corresponding to the currently specified edited content is searched for, read and then acquired. If the information of the edit content is stored in a database form on the non-volatile memory 17, a required edit content is read from the database, and edit-control information is organized in a predetermined form. For example, the edit-control information is subjected to a compile process using the XML analysis function 204, and then converted into XML edit-control information.

The edit-control information thus acquired is expanded onto the RAM 16 so that an environment permitting the CPU 14 to analyze and interpret the edit-control information (in the edit and reproduction process) through the XML analysis function 204 is provided. In step S204, the edit-control information is transmitted to the AV content recording and reproducing apparatus 1B via the network 3. The transmission of the edit-control information in step S204 also serves as a request to start the reproduction of the edited content.

Upon receiving the edit-control information, the AV content recording and reproducing apparatus 1B transfers the edit-control information to the RAM 16 from the network interface 18 for storage. An environment permitting the CPU 14 to analyze and interpret the edit-control information is thus provided. In step S205, the edit-control information is interpreted, and the data of the main content stored on the storage unit 13 is searched for. As shown in FIG. 6, a content defined as Video and Audio is the main content and can be searched for according to Content ID=A, Content ID=B, and Content ID=C.

In step S206, the CPU 14 determines whether these main contents have been found in the search. The CPU 14 determines here whether all main contents specified by the edit-control information have been found in the search.

The users of the AV content recording and reproducing apparatuses 1A and 1B may mistakenly believe that all main contents for the edited content are commonly stored. In such a case, the synchronized reproduction may not be performed on the original content data. If it is determined in step S206 that not all main contents specified by the edit-control information are found, an error notification is transmitted to the AV content recording and reproducing apparatus 1A in step S207-1.

If it is determined in step S206 that all main contents specified by the edit-control information are found in the search, an Ack is transmitted to the AV content recording and reproducing apparatus 1A in step S207-2.

The AV content recording and reproducing apparatus 1A having transmitted the edit-control information (request to start the edited content reproduction) in step S204 waits on standby in step S208 for the Ack in response to the transmission of the edit-control information (request to start the edited content reproduction).

If it is determined in step S208 that the error notification has been received in response to step S207-1, a non-affirmative determination result is obtained. In step S209, an error process is performed. For example, a predetermined process, such as showing a message notifying the user that the synchronized reproduction cannot be performed, is performed, and a subsequent synchronized reproduction is suspended.

If the Ack is received in response to the process in step S207-2, an affirmative determination result is obtained in step S208. In step S210, the reproduction of the edited content (edit and reproduction process) is thus performed. The edit-control information stored on the RAM 16 is successively interpreted, and the CPU 14 performs the edit and reproducing process in reproduction time axis so that a reproduction output responsive to a command of the edit-control information is obtained.

In response to the affirmative determination result in step S206, the AV content recording and reproducing apparatus 1B returns the Ack in step S207-2, and similarly starts the reproduction-process of the edited content in step S211.

The timing the AV content recording and reproducing apparatus 1A recognizes the Ack returned in step S207-2 and the timing the AV content recording and reproducing apparatus 1B recognizes the affirmative determination result in step S206 fall within a time difference range generally considered to be concurrent in practice unless any trouble causes a time lag between the transmission of the Ack and the reception of the Ack. Therefore, the timing the AV content recording and reproducing apparatus 1A performs step S10 subsequent to the recognition of the Ack in step S208 and the timing the AV content recording and reproducing apparatus 1B executes step S211 subsequent to the acquisition of the search result in step S206 are also considered to be concurrent.

In accordance with the present embodiment, with respect to the transmission and the reception of the Ack in step S207-2, the reproduction of the edited content is reproduced in the AV content recording and reproducing apparatuses 1A and 1B at the substantially same timings. A plurality of AV content recording and reproducing apparatuses 1 can thus perform the synchronized reproduction of the edited contents.

Steps S212, S213, S214, and S215 are to be performed at appropriate timings subsequent to the start of the reproduction of the edited content in steps S210 and S211.

In step S212, the AV content recording and reproducing apparatus 1A transmits a sub content to the AV content recording and reproducing apparatus 1B at a predetermined timing for a reproduction period. The data to be transmitted in step S212 contains the data of text and the video data of television telephone previously discussed with reference to FIG. 5. If still image data is inserted into the edited content depending on the edit content, such data is also transmitted as the data of the sub content. In step S213, the AV content recording and reproducing apparatus 1B transmits a sub content to the AV content recording and reproducing apparatus 1A at a predetermined timing during the reproduction period. For example, the data of the sub content such as the text is transmitted to the AV content recording and reproducing apparatus 1B (the slave apparatus) by the AV content recording and reproducing apparatus 1A (the master apparatus) having edited the data. The data of the sub content transmitted from the AV content recording and reproducing apparatus 1B to the AV content recording and reproducing apparatus 1A is the video data of the television telephone captured on the AV content recording and reproducing apparatus 1B.

Information such as the text as the sub content data may be transmitted as the data of an object accompanying the edit-control information when the edit-control information is transmitted in step S204, and may be then stored in the AV content recording and reproducing apparatus 1B prior to the reproduction process.

In step S214, the AV content recording and reproducing apparatus 1A transmits to the AV content recording and reproducing apparatus 1B operation commands relating to reproduction in response to reproduction operations of the user input to the operation unit 19 (other than a stop command). In step S215, the AV content recording and reproducing apparatus 1B transmits to the AV content recording and reproducing apparatus 1A operation commands relating to reproduction. The operation commands to be transmitted and received in steps S214 and S215 include a fast-forward command, a fast-reverse command, and a pause command.

In accordance with the present embodiment, reproduction time for the edited content is defined in the edit-control information. The operation commands transmitted and received in steps S214 and S215 have a format controlling the reproduction of the edited content in accordance with XML. For example, in response to the fast-forward command and the fast-reverse command, the reproduction output is provided so that the reproduction time counting is moved in a forward direction or a backward direction at a speed a predetermined number of times the standard speed. In the case of the pause command, the reproduction output is provided so that the video is displayed in a still-image mode with the reproduction time counting stopped.

For example, when the AV content recording and reproducing apparatus 1B is ready to reply upon receiving the operation command transmitted from the AV content recording and reproducing apparatus 1A in step S214, the AV content recording and reproducing apparatus 1B returns the Ack. In accordance with the received operation command, the AV content recording and reproducing apparatus 1B changes the form of the reproduction output of the edited content currently reproduced by the AV content recording and reproducing apparatus 1B. Upon receiving the Ack, the AV content recording and reproducing apparatus 1A changes the reproduction output form of the edited content currently reproduced by the AV content recording and reproducing apparatus 1A in response to the same operation command transmitted in step S214. When the AV content recording and reproducing apparatus 1B transmits an operation command to the AV content recording and reproducing apparatus 1A in step S215, the transmission and the reception of the Ack and the reproduction output form of the edited content reproduced by own apparatus are performed in a manner opposite to the manner described above.

If the operation commands are normally transmitted and received in steps S214 and S215 and the ACK responsive to the operation command are normally transmitted and received, the timing of the AV content recording and reproducing apparatus 1A and the timing of the AV content recording and reproducing apparatus 1B fall within a time difference range generally considered to be concurrent in practice with respect to the transmission and reception timings of the Ack. More specifically, the timing the AV content recording and reproducing apparatus 1A changes the form of the reproduction output of the edited content currently reproduced by itself is concurrent with the timing the AV content recording and reproducing apparatus 1B changes the form of the reproduction output in response to the received operation command. In the synchronized reproduction of the edited content, reproduction operations such as the fast-forward operation, the fast-reverse operation, and the pause operation are also performed in synchronization.

Depending on the type of the edited content and the usage of the content, it may be unpreferable for operation to be performed from each of the AV content recording and reproducing apparatuses 1A and 1B. In one arrangement, operation is performed from only the AV content recording and reproducing apparatus 1A as a master apparatus. To this end, an operation relating to the reproduction of the edited content, if performed, is invalidated on the AV content recording and reproducing apparatus 1B functioning as a slave apparatus.

The AV content recording and reproducing apparatus 1A is thus enabled to accept the operation input. The AV content recording and reproducing apparatus 1B is designed to determine whether to invalidate an operation command transmitted from the AV content recording and reproducing apparatus 1A. For example, upon receiving the operation command, the AV content recording and reproducing apparatus 1B notifies the user of the content of the operation command and displays a screen urging the user to determine whether to invalidate the operation command. Viewing the screen, the user of the AV content recording and reproducing apparatus 1B operates the AV content recording and reproducing apparatus 1B to determine whether to validate or not the operation command.

If the user has operated the AV content recording and reproducing apparatus 1 to validate the operation command, the AV content recording and reproducing apparatus 1B transmits the Ack (notification that the operation command has been received) to the AV content recording and reproducing apparatus 1A, and then changes the reproduction output form of the edited content in response to the operation command. Upon receiving the Ack (notification that the operation command has been received), the AV content recording and reproducing apparatus 1A changes the reproduction output change of the edited content in response to the same operation command. The synchronized reproduction is thus performed. If the user has operated the AV content recording and reproducing apparatus 1B to invalidate the operation command, the AV content recording and reproducing apparatus 1B does not return the Ack, or notifies the AV content recording and reproducing apparatus 1A that the operation command has been denied. With the, operation command invalidated, the AV content recording and reproducing apparatus 1B does not change the reproduction output form of the edited content responsive to the operation command. The AV content recording and reproducing apparatus 1A has not received the Ack (notification that the operation command has been accepted), and does not change the reproduction output form of the edited content.

The stopping of the reproduction of the edited content is performed from the AV content recording and reproducing apparatus 1A as the master apparatus.

In response to the end of the reproduction time of the edited content or in response to an operation to stop the reproduction, the AV content recording and reproducing apparatus 1A transmits a command requesting the stop of the reproduction operation in step S216. Upon receiving the stop request command, the AV content recording and reproducing apparatus 1B transmits a response indicating stop OK in step S217 in the condition that the stop of the reproduction of the edited content is permitted. Upon receiving the response, the AV content recording and reproducing apparatus 1A transmits a stop command, and the AV content recording and reproducing apparatus 1B returns the Ack in response to the reception of the stop command. Upon transmitting the Ack, the AV content recording and reproducing apparatus 1B stops the reproduction of the edited content in step S221. In response to the reception of the Ack transmitted in step S219, the AV content recording and reproducing apparatus 1A stores the reproduction of the edited content. The stopping of the reproduction of the edited content is performed in synchronization on the AV content recording and reproducing apparatuses 1A and 1B with respect to the transmission and reception timings of the Ack in step S219.

The synchronized reproduction of the edited content is performed between the two AV content recording and reproducing apparatuses 1A and 1B in the above embodiment. The synchronized reproduction of the edited content is performed among three or more AV content recording and reproducing apparatuses 1 in the above described arrangement. One of three or more AV content recording and reproducing apparatuses 1 is set to be a master apparatus, and the remaining AV content recording and reproducing apparatuses 1 may be set to be slave apparatuses in the above described arrangement. In such a system, the edit-control information (reproduction start request) is concurrently transmitted from the master to a plurality of slaves in a uni-cast fashion, and the slave apparatuses then return Ack in response. With respect to the transmission and reception timings of Ack, the reproduction of the edited content starts. The synchronized reproduction of the edited content is thus possible.

The synchronized reproduction of the edited content using three or more AV content recording and reproducing apparatuses 1 is effectively applied to correspondence course. A lecturer may use the AV content recording and reproducing apparatus 1A as a master apparatus, and students who take a course use other AV content recording and reproducing apparatuses 1 as slave apparatuses.

In accordance with embodiments of the present invention, the following system may be configured. The system includes a transmitting apparatus and a receiving and reproducing apparatus. The transmitting apparatus only transmits the edit-control information and does not perform the reproduction of the edited content. In response to the edit-control information transmitted from the transmitting apparatus, the receiving and reproducing apparatus performs the edit and reproducing process on a content data stored thereon as an edit material.

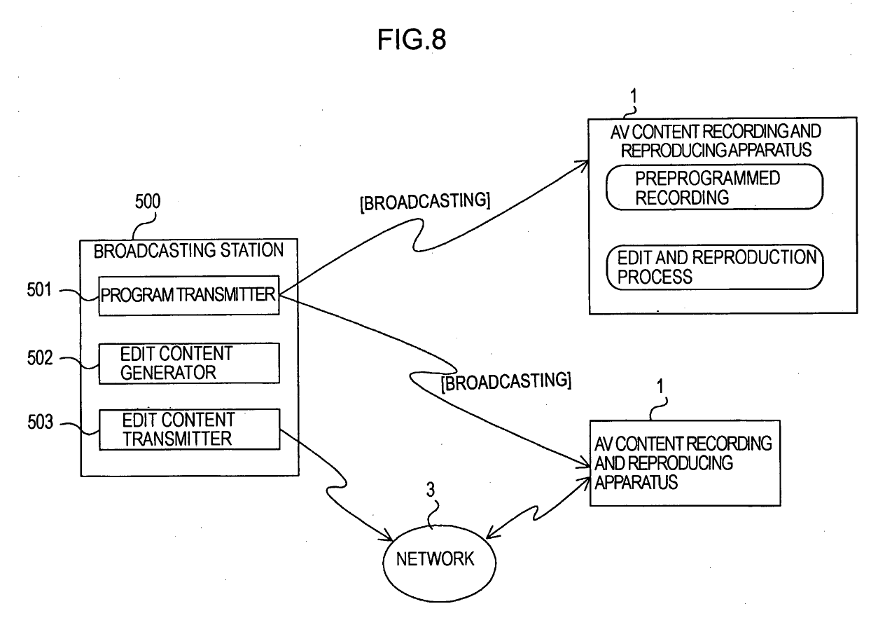

A variety of applications of such a system are contemplated. FIG. 8 illustrates one example of applications.

A broadcasting station 500 is shown as a facility equipped with an apparatus for a television broadcasting operation. The broadcasting station 500, corresponding to the above-mentioned transmitting apparatus, performs digital television broadcasting.

FIG. 8 illustrates a plurality of AV content recording and reproducing apparatuses 1. Each of the AV content recording and reproducing apparatuses 1 corresponds to the receiving and reproducing apparatus.

The broadcasting station 500 includes a program transmitter 501, an edit content generator 502, and an edit content transmitter 503. The program transmitter 501 broadcasts audio and video information as a television program, and is composed of a facility for transmitting, in the form of radio wave, audio and video data as a program complying with digital television broadcasting standards. The edit content generator 502 produces an edited content by editing an audio and video as a broadcast program, and is composed of a computer having editing application software programs (such as an authoring software program) installed thereon. The edit content generator 502 corresponds to the editing function 203 previously discussed. As previously discussed, the content of the edit results is XML edit-control information (and the sub content data).

The edit content transmitter 503 transmits the edited content produced by the edit content generator 502 to the AV content recording and reproducing apparatus 1 via the network 3. The edit content transmitter 503 may be a server that stores the produced edited content and has a network communication function for transmitting the edited content to the AV content recording and reproducing apparatus 1 via the network 3.

As described above, additional information to programs are defined by the ARIB standards in the digital television broadcasting. Recording apparatuses performing a preprogrammed recording by category using the additional information are known. The AV content recording and reproducing apparatus 1 of the embodiments of the present invention is also provided with such a preprogrammed recording function. Depending on the type of the preprogrammed recording function, a large number of programs of a particular category are recorded. Because of insufficient time available, the user cannot view all programs.

On the side of television broadcasting operator (broadcasting station 500), the edit content generator 502 extracts a highlight portion of the content or a digest version of the content from a program of a particular category broadcast in the past time slot, and generates an edited content by concatenating the highlight portions. The edit-control information (and the content data) as the edited content is distributed from the edit content transmitter 503 via the network 3, and the AV content recording and reproducing apparatus 1 downloads the edit-control information for storage.

As previously discussed, the AV content recording and reproducing apparatus 1 having downloaded the edit-control information starts the synchronized reproduction of the edited content by processing the edit-control information. The material of the content reproduced as the digest version of the edited content is a program of a particular category stored on a local memory of the recording apparatus. Since the edit-control information is produced by the broadcast operator, identification information unique to the program defined in the ARIB standard may be used for specifying a reproduction content. If the AV content recording and reproducing apparatus 1 simply stores the program for recording, the recorded program which is edited as a producer of the edited content intends is reproduced using the ARIB additional information attached to the audio and video data of the recorded program. The entire content data of the recorded program specified by the edit-control information is not necessarily stored on the recording apparatus. If the content data specified by the edit-control information is not stored on the recording apparatus, the edit-control information is preferably described so that time for reproducing that content data is skipped followed by the reproduction of next content data.

The following function may be incorporated to handle the digest version of the edited content. If the user may like a recorded program during the reproduction of the edited content, a predetermined operation may be performed to specify the program. In response to the predetermined operation, the reproduction of the edited content is stopped, followed by the reproduction of the specified recorded program. The recorded program of the edited content reproduced is the one locally stored on the recording apparatus. In response to a link operation, accessing to the link destination is a technique using XML. The above discussed function is easily incorporated.

The present invention is not limited to the embodiments discussed above. For example, application fields other than the above-referenced application fields are contemplated as those of the preceding embodiments. Each of the reproducing apparatus, the transmitting apparatus, and the receiving and reproducing apparatus, as the master apparatus or the slave apparatus, is not limited to the AV content recording and reproducing apparatus 1. A variety of architectures are contemplated for the reproducing apparatus, the transmitting apparatus, and the receiving and reproducing apparatus.

The XML format is incorporated for the edit-control information in the preceding embodiments. Alternatively, a markup language, programs of a variety of languages, and script may be used for the edit-control information.

It should be understood by those skilled in the art that various modifications, combinations, sub-combinations and alterations may occur depending on design requirements and other factors insofar as they are within the scope of the appended claims or the equivalents thereof.

What is claimed is:

1. A reproducing system comprising a master apparatus, at least one slave apparatus, and a communication unit for performing communications via a predetermined communication network between the master apparatus and the slave apparatus,
wherein the master apparatus includes:
a first storage unit for storing data;
an edit-control information transmission control unit for transmitting, to the slave apparatus via the communication unit, edit-control information which is required to perform an edit and reproduction operation using, as an edit material, edit object data containing at least one unit of data stored on the first storage unit; and
a synchronization unit for synchronizing a reproduction output of the master apparatus with a reproduction output of the slave apparatus in reproduction sequence, the reproduction output of the master apparatus being output by performing the edit and reproduction operation using the edit object data as the edit material stored on the first storage unit based on edit-control information identical to the edit-control information transmitted by the edit-control information transmission control unit, and the reproduction output of the slave apparatus being output by performing the edit and reproduction operation using the edit object data as the edit material stored on a second storage unit, based on the edit-control information received from the edit-control information transmission control unit; and
wherein the slave apparatus includes the second storage unit.

2. A reproducing apparatus comprising:
a communication unit for performing, via a predetermined communication network, communications with another reproducing apparatus serving as a slave apparatus;
a first storage unit for storing data;
an edit-control information transmission control unit for transmitting, to the other reproducing apparatus via the communication unit, edit-control information which is required to perform an edit and reproduction operation using, as an edit material, edit object data containing at least one unit of data stored on the first storage unit;
an edit and reproducing unit for providing a reproduction output by performing the edit and reproducing operation using as the edit material the edit object data stored on the first storage unit based on the edit-control information identical to the edit-control information transmitted by the edit-control information transmission control unit; and
a synchronization unit for synchronizing the reproduction output of the edit and reproducing unit with a reproduction output of the other apparatus in reproduction sequence, the reproduction output of the other reproducing apparatus being output by performing the edit and reproduction operation using the edit object data as the edit material stored on a second storage unit of the other reproducing apparatus, based on the edit-control information received from the edit-control information transmission control unit.

3. The reproducing apparatus according to claim 2, wherein the synchronization unit comprises a command information transmitter for causing the communication unit to transmit to the other reproducing apparatus command information commanding the start of the edit and reproduction operation of the edit object data, and
wherein the edit and reproducing unit starts the edit and reproducing operation on the edit object data in response to the reception of notification information that the other reproducing apparatus has transmitted in response to the reception of the command information, the notification information indicating that the other reproducing apparatus has started the edit and reproducing operation of the edit object data.

4. The reproducing apparatus according to claim 2, further comprising:
an information storage unit for storing preprogrammed recording setting information of a program;
a preprogrammed recording information transmitting unit for transmitting via the communication unit the preprogrammed recording setting information stored on the information storage unit to the other reproducing apparatus, the other reproducing apparatus having the function of performing a preprogrammed recording operation for storing, on the second storage unit, data of the program received in accordance with the preprogrammed recording setting information; and
a preprogrammed recording executing unit for storing on the first storage unit the data of the program received in accordance with the preprogrammed recording setting information stored on the information storage unit.

5. The reproducing apparatus according to claim 2, further comprising an operation input unit for receiving an operation input relating to the reproduction output that is output by the edit and reproducing unit,
wherein the edit and reproducing unit modifies a form of the reproduction output in response to the operation input received by the operation input unit, and
wherein the synchronization unit modifies a form of the reproduction output of the edit object data in the other reproducing apparatus in response to the operation input received by the operation input unit.

6. A reproducing apparatus comprising:
a communication unit for performing, via a predetermined communication network, communications with another reproducing apparatus serving as a master apparatus;
a second storage unit for storing data;
an edit and reproducing unit for providing a reproduction output by performing an edit and reproducing operation using, as an edit material, edit object data recorded on the second storage unit and specified by edit-control information, the edit-control information being received from the other reproducing apparatus by the communication unit and being required to perform the edit and reproducing operation; and
a synchronization unit for synchronizing the reproduction output of the edit and reproducing unit with a reproduction output of the other apparatus in reproduction sequence, the reproduction output of the other reproducing apparatus being output by performing the edit and reproduction operation, using the edit object data as the edit material stored on a first storage unit of the other reproducing apparatus, based on edit-control information identical to the edit-control information transmitted by the other reproducing apparatus.

7. The reproducing apparatus according to claim 6, wherein when command information commanding the start of the edit and reproducing operation of the edit object data is received by the communication unit from the other reproducing apparatus, the synchronization unit transmits notification information to the other reproducing apparatus via the communication unit at a predetermined timing, the notification information notifying of the start of the edit and reproducing operation of the edit object data by the edit and reproducing unit.

8. The reproducing apparatus according to claim 6, further comprising:
an information storage unit for storing preprogrammed recording setting information of a program;
a preprogrammed recording executing unit for storing, on the second storage unit, data of the program received in accordance with the preprogrammed recording setting information stored on the information storage unit; and
a storage control unit for causing the information storage unit to store the preprogrammed recording setting information transmitted from the other reproducing apparatus via the communication unit, the other reproducing apparatus having the function of performing a preprogrammed recording operation for storing, on the first storage unit, the data of the program received in accordance with the preprogrammed recording setting information.

9. The reproducing apparatus according to claim 6, further comprising an operation input unit for receiving an operation input relating to the reproduction output that is output by the edit and reproducing unit,
wherein the edit and reproducing unit modifies a form of the reproduction output in response to the operation input received by the operation input unit, and
wherein the synchronization unit modifies a form of the reproduction output of the edit object data in the other reproducing apparatus in response to the operation input received by the operation input unit.

10. A reproducing method of a reproducing system comprising a master apparatus and at least one slave apparatus, comprising:
a communication step of performing communications via a predetermined communication network between the master apparatus and the slave apparatus;
a transmission control step of transmitting to the slave apparatus, in the communication step, edit-control information which is required to perform an edit and, reproduction operation using, as an edit material, edit object data containing at least one unit of data stored on a first storage unit of the mater apparatus; and
a synchronization step of synchronizing a reproduction output of the master apparatus with a reproduction output of the slave apparatus in reproduction sequence, the reproduction output of the master apparatus being output by performing the edit and reproduction operation using the edit object data as the edit material stored on the first storage unit based on edit-control information identical to the edit-control information transmitted in the transmission control step, and the reproduction output of the slave apparatus being output by performing the edit and reproduction operation using the edit object data as the edit material stored on a second storage unit of the slave apparatus, based on the edit-control information transmitted in the transmission control step.

11. A reproducing system comprising a transmitting apparatus, at least one receiving and reproducing apparatus, and a communication unit for performing communications via a predetermined communication network between the transmitting apparatus and the receiving and reproducing apparatus,
wherein the transmitting apparatus includes:
an edit-control information generating unit for generating edit-control information required to execute an edit and reproducing operation using predetermined edit object data as an edit material;
an edit-control information transmission control unit for transmitting the edit-control information to the receiving and reproducing apparatus via the communication unit; and
wherein the receiving and reproducing apparatus includes:
a storage unit for storing data; and
an edit and reproducing unit for providing a reproduction output by performing an edit and reproducing operation using the edit object data stored on the storage unit as an edit material, based on the edit-control information received from the edit-control information transmission control unit.

12. A receiving and reproducing apparatus comprising:
a communication unit for performing communications with a transmitting apparatus via a predetermined communication network;
a storage unit for storing data; and
an edit and reproducing unit for providing a reproduction output by performing an edit and reproducing operation using edit object data as an edit material stored on the storage unit, based on edit-control information transmitted from the transmitting apparatus, received by the communication unit, and required to execute the edit and reproducing operation on the edit object data.

13. The receiving and reproducing apparatus according to claim 12, further comprising a video recording unit for storing audio and video information of a program onto the storage unit as the data,
wherein the edit and reproducing unit provides a reproduction output by performing an edit operation on the audio and video information stored on the storage unit based on the edit-control information containing at least one piece of audio and video information as the edit object data.

14. A reproducing method of a reproducing system including a transmitting apparatus, and at least one receiving and reproducing apparatus having a storage unit, comprising:
a communication step of performing communications via a predetermined communication network between the transmitting apparatus and the receiving and reproducing apparatus;
an edit-control information generating step of generating edit-control information required to execute an edit and reproducing operation using predetermined edit object data as an edit material;
an edit-control information transmission control step of transmitting the edit-control information to the receiving and reproducing apparatus in the communication step; and
a reproduction output steps of providing a reproduction output by performing an edit and reproducing operation using the edit object data as an edit material stored on the storage unit, based on the edit-control information transmitted in the edit-control information transmission control step.
